(19) United States
(12) Patent Application Publication
(10) Pub. No.: US 2026/0347708 A1
(43) Pub. Date: Nov. 5, 2026

(54) DEMULSIFIER COMPOSITION HAVING A BRANCHED POLYGLYCEROL AND METHOD OF USING THE SAME TO SEPARATE AN EMULSION

(71) Applicant: Saudi Arabian Oil Company, Dhahran (SA)

(72) Inventors: Muhammad Imran Ul-haq, Dhahran (SA); Manal Al-Eid, Dhahran (SA); Emmanuel Oladeji Ajayi, Dhahran (SA)

(21) Appl. No.: 19/182,031

(22) Filed: Apr. 17, 2025

(51) Int. Cl. C10G 33/04; C08F 216/14

(52) U.S. Cl. CPC C10G 33/04; C08F 216/1425; C10G 2300/1033

(57) ABSTRACT

The present disclosure provides a demulsifier composition. The demulsifier composition includes a solvent and a polymer. The polymer has a general formula [R1-Ph-O]m-(PO)n-(PG)o or [R1-Ph-O]m-(PO)n-(PG)o-(EO)p, where R₁ is a C₁-C₂₀ alkyl, PO is propylene oxide, PG is polyglycerol, EO is ethylene oxide, and m, n, o, and p are integers independently selected from greater than or equal to 1 to less than or equal to 100.

### TECHNICAL FIELD

Embodiments of the disclosure generally relate to a demulsifier composition. More specifically, embodiments of the present disclosure relate to a demulsifier composition having a branched polyglycerol and a method of using the same to separate an emulsion.

### BACKGROUND

Crude oil emulsions form when crude oil comes into contact with water during extraction from the reservoir. Although crude oil and water are initially in separate phases, the turbulent flow in pipes and presence of surface-active substances that naturally occur in crude oil may cause the water and crude oil to form a stable emulsion. These emulsions are undesirable because the destruction and treatment of the emulsion adds to production cost and can cause loss of valuable amounts of crude oil. The presence of water in crude can corrode the refinery equipment, poison catalysts in downstream processing facilities, and increase pumping cost for transporting the fluid in the pipeline. Water can also trip equipment present in a gas oil separation plant (GOSP), and cause high pressure drops in flow lines. Demulsifiers may be used to disrupt the emulsion and to separate water from crude oil during the crude oil production process.

### SUMMARY

An embodiment of the present disclosure relates to a demulsifier composition. A composition including a solvent and a polymer having a structure according to the following formula (I):

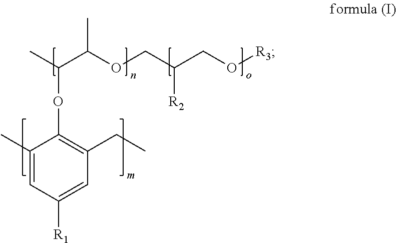

where R₁ is a C₁-C₂₀ alkyl;
where R₂ comprises a linear or branched polyglycerol;
where R₃ is selected from a C₁-C₃ alkyl or a group represented by the following formula

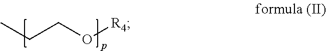

where R₄ is a C₁-C₃ alkyl; and
where m, n, o, and p are integers independently ranging from ≥1 and ≤100.

Another embodiment of the present disclosure provides a method. The method includes providing a demulsifier composition to a flowline in fluid communication with a portion of the subterranean formation, where the flowline comprises an emulsion that contains an aqueous phase and an oil phase. The demulsifier composition includes a solvent and a polymer having a structure according to the following formula (I):

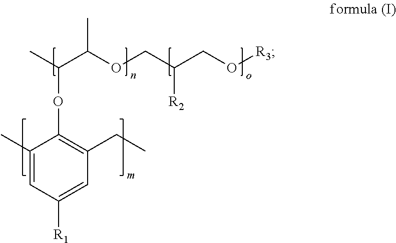

where R₁ is a C₁-C₂₀ alkyl;
where R₂ comprises a linear or branched polyglycerol;
where R₃ is selected from a C₁-C₃ alkyl or a group represented by the following formula (II).

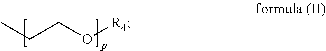

where R₄ is a C₁-C₃ alkyl; and
where m, n, o, and p are integers ranging from ≥1 and ≤100.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF THE DRAWINGS

FIG. 1 is a schematic illustration of a system according to embodiments of the present disclosure.

FIG. 2 is a method of producing a demulsifier composition according to embodiments of the present disclosure.

FIG. 3 is a graph of separated water volume versus time of the demulsifier compositions at 30 ppm and 130 °F.

FIG. 4 is a graph showing water separation efficiency versus time for the demulsifier compositions at 30 ppm and 130 °F.

In general, like reference numbers and designations in the various drawings indicate like elements.

### DETAILED DESCRIPTION

One technical issue associated with ethylene oxide and propylene oxide demulsifiers is that, with increasing water cuts within produced fluid from a subterranean formation, the ethylene oxide and propylene oxide demulsifiers can have limited performance for early dewatering of emulsions. Embodiments of the present disclosure include a demulsifier composition that can provide practical applications and technical features that can address the aforementioned potential issues. In some embodiments, the provided demulsifier composition includes a polymer comprising an alkylphenol group and a polyglycerol group (e.g., hyperbranched polyglycerol). Without wishing to be bound to a particular theory, it is contemplated that the alkylphenol group and the polyglycerol group can work synergistically in combination to provide multiple branches within the polymer that improve water droplet coalescence and, ultimately, can achieve higher water separation from an oil-water emulsion. In some embodiments, the provided polymer in the demulsifier composition may also solve an issue associated with emulsions drying out too quickly. The provided polymer may also improve performance by having improved solubility, improved viscosity, and may reduce foaming ability relative to ethylene oxide and propylene oxide demulsifiers.

Embodiments of the present disclosure provide a composition. In some embodiments, the composition is a demulsifier composition. In general, a demulsifier is a compound that is configured to separate an emulsion. For example, an emulsion may include a mixture of two or more liquids that are not normally soluble in each other but are temporarily mixed together. For example, the emulsion may include an aqueous phase and an oil phase, where one of the phases is dispersed in the other (e.g., as droplets). The demulsifier is configured to separate at least a portion of the aqueous phase from the oil phase (e.g., dewater the emulsion). As used herein, a “demulsifier” may refer to a composition that, when applied to an oil field emulsion, obtains a separation efficiency percentage (%) of at least 50%, at least 60%, at least 70%, at least 80%, and/or up to 90%, up to 95%, or up to 100%. In some embodiments, the oil field emulsion contains at least 40% water cut to at most 85% water cut. In some embodiments, the oil field emulsion contains at least 40% water cut, at least 45%, at least 50%, and/or to at most 55%, at most 60%, at most 65%, at most 70%, at most 75%, at most 80%, or at most 85% water cut. In some embodiments, the demulsifier is applied to the oil field emulsion for a duration of at least five seconds to at most five hours to obtain the specified separation efficiency %. In some embodiments, the duration is at least five seconds, at least 30 seconds, at least one minute, at least five minutes, at least ten minutes, at least 15 minutes, at least 20 minutes, at least 30 minutes, and/or at most one hour, at most two hours, at most three hours, at most four hours, or at most five hours.

In some embodiments, the demulsifier composition may include a polymer and a solvent. In some embodiments, the polymer has a structure according to the following formula (I):

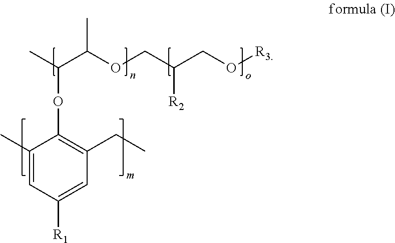

In some embodiments, R₁ is an alkyl. As used herein, the term “alkyl” may refer to a straight-chain or branched alkyl radical in all of its isomeric forms, such as straight or branched group. In some embodiments, R₁ is a C₁-C₂₀ alkyl. In some embodiments, R₁ is a C₁-C₁₉ alkyl, a C₁-C₁₈ alkyl, a C₁-C₁₇ alkyl, a C₁-C₁₆ alkyl, a C₁-C₁₅ alkyl, a C₁-C₁₄ alkyl, a C₁-C₁₃ alkyl, a C₁-C₁₂ alkyl, a C₁-C₁₁ alkyl, a C₁-C₁₀ alkyl, a C₁-C₉ alkyl, a C₁-C₈ alkyl, a C₁-C₇ alkyl, a C₁-C₆ alkyl, or a C₁-C₅ alkyl. In some embodiments, R₁ is a C₅-C₁₂ alkyl, a C₅-C₁₁ alkyl, a C₅-C₁₀ alkyl, or a C₅-C₉ alkyl.

In some embodiments, R₂ comprises a linear or branched polyglycerol. In certain particular embodiments, R₂ is a hyperbranched polyglycerol. In some embodiments, the linear or branched polyglycerol has from 6 to 120 carbon atoms or from 6 to 60 carbon atoms. In some embodiments, the linear or branched polyglycerol has at least 6 carbon atoms (e.g., at least 9 carbon atoms, at least 12 carbon atoms, at least 15 carbon atoms, at least 18 carbon atoms, at least 21 carbon atoms, at least 24 carbon atoms, at least 27 carbon atoms, at least 30 carbon atoms, at least 33 carbon atoms, at least 36 carbon atoms, at least 39 carbon atoms, at least 42 carbon atoms, at least 45 carbon atoms, at least 48 carbon atoms, at least 51 carbon atoms, at least 54 carbon atoms, at least 57 carbon atoms), and/or at most 120 carbon atoms (e.g., at most 60 carbon atoms, at most 72 carbon atoms, at most 84 carbon atoms, at most 96 carbon atoms, at most 108 carbon atoms, or at most 120 carbon atoms).

In some embodiments, R₃ is selected from a C₁-C₃ alkyl or a group represented by the following formula (II):

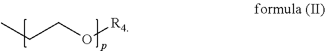

In some embodiments, R₄ is a C₁-C₃ alkyl. In some embodiments, m, n, o, and p are integers independently ranging from ≥1 and ≤100. In one non-limiting group of examples, m is an integer that is greater than or equal to 1 (e.g., greater than or equal to 2, greater than equal to 3, greater than or equal to 4, greater than or equal to 5, or greater than or equal to 6) and/or less than or equal to 15 (e.g., less than or equal to 15, less than or equal to 14, less than or equal to 13, less than or equal to 12, less than or equal to 11, less than or equal to 10, less than or equal to 9, less than or equal to 8, or less than or equal to 7).

In another non-limiting group of examples, n is an integer that is greater than or equal to 1 (e.g., greater than or equal to 2, greater than equal to 3, greater than or equal to 4, greater than or equal to 5, greater than or equal to 6, greater than or equal to 7, greater than or equal to 8, greater than or equal to 9, greater than or equal to 10, greater than or equal to 15, greater than or equal to 20, greater than or equal to 25, greater than or equal to 30, greater than or equal to 35, greater than or equal to 40, greater than or equal to 45, or greater than or equal to 50) and/or less than or equal to 100 (e.g., less than or equal to 95, less than or equal to 90, less than or equal to 85, less than or equal to 80, less than or equal to 75, less than or equal to 70, less than or equal to 65, less than or equal to 60, or less than or equal to 55).

In one non-limiting group of examples, o is an integer that is greater than or equal to 1 (e.g., greater than or equal to 2, greater than equal to 3, greater than or equal to 4, greater than or equal to 5, greater than or equal to 6, greater than or equal to 7, greater than or equal to 8, greater than or equal to 9, greater than or equal to 10, greater than or equal to 15, greater than or equal to 20, greater than or equal to 25, greater than or equal to 30, or greater than or equal to 35) and/or less than or equal to 60 (e.g., less than or equal to 55, less than or equal to 50, less than or equal to 45, or less than or equal to 40).

In some embodiments, p is an integer that is greater than or equal to 1 (e.g., greater than or equal to 10, greater than or equal to 20, greater than or equal to 30, greater than or equal to 35, greater than or equal to 40, greater than or equal to 45, or greater than or equal to 50) and/or less than or equal to 80 (e.g., less than or equal to 75, less than or equal to 70, less than or equal to 65, less than or equal to 60).

In some embodiments, R₂ is a hyperbranched polyglycerol. For example, R₂ may correspond to a group represented by the following formula (III):

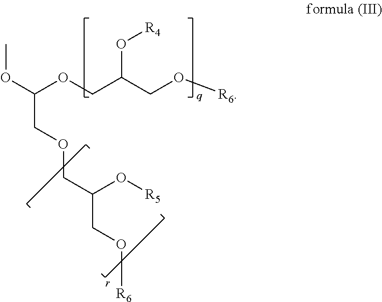

In some embodiments, q and r are integers independently ranging from greater than or equal to 1 or less than or equal to 15. In some embodiments, q and r are integers independently ranging from greater than or equal to 1 (e.g., greater than or equal to 2, greater than or equal to 3, greater than or equal to 4, greater than or equal to 5, or greater than or equal to 6) to less than or equal to 15 (e.g., less than or equal to 7, less than or equal to 8, less than or equal to 9, less than or equal to 10, less than or equal to 11, less than or equal to 12, less than or equal to 13, or less than or equal to 14).

In some embodiments, R₄ and R₅ are independently selected from hydrogen or a group represented by the following formula (IV):

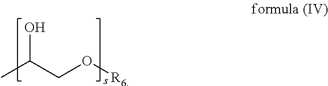

In some embodiments, s is an integer ranging from greater than or equal to 1 or less than or equal to 15. In some embodiments, s is an integer ranging from greater than or equal to 1 (e.g., greater than or equal to 2, greater than or equal to 3, greater than or equal to 4, greater than or equal to 5, or greater than or equal to 6) to less than or equal to 15 (e.g., less than or equal to 7, less than or equal to 8, less than or equal to 9, less than or equal to 10, less than or equal to 11, less than or equal to 12, less than or equal to 13, or less than or equal to 14).

In some embodiments, R₆ is selected from hydrogen or a group represented by the following formula (V):

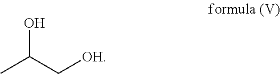

In some embodiments, the solvent comprises an aromatic solvent, a polar organic solvent, or a combination thereof. In some embodiments, the aromatic solvent is selected from benzene, toluene, ethyl benzene, xylene, or a combination thereof. In some embodiments, the polar organic solvent comprises methanol. In some embodiments, the solvent is present in the demulsifier composition in an amount of at least 30 wt. % or less than 75 wt. %, based on a total weight of the demulsifier composition. In some embodiments, the solvent is present in an amount from at least 30 wt. % (e.g., at least 35 wt. %, at least 40 wt. %, at least 45 wt. %, at least 50 wt. %, at least 55 wt. % or at least 60 wt. %) to less than 75 wt. % (e.g., less than 70 wt. % or less than 65 wt. %). In some embodiments, the polymer is present in the demulsifier composition in an amount of at least 25 wt. % or less than 50 wt. %, based on the total weight of the demulsifier composition. In some embodiments, the polymer is present in an amount of at least 25 wt. % (e.g., at least 30 wt. %, at least 35 wt. %, or at least 40 wt. %) to less than 50 wt. % (e.g., less than 45 wt. %).

In some embodiments, the polymer has a number average molecular weight (Mₙ) of at least 3,800 g/mol or less than 4,500 g/mol. In some embodiments, the Mₙ of the polymer is at least 3,800 g/mol (e.g., at least 3,900 g/mol, at least 4,000 g/mol, at least 4,100 g/mol, or at least 4,200 g/mol) to less than 4,500 g/mol (e.g., less than 4,400 g/mol or less than 4,300 g/mol). In some embodiments, the polymer has a weight average molecular weight (M_{w}) of at least 8,000 g/mol or less than 12,000 g/mol. In some embodiments, the polymer has a M_{w} from at least 8,000 (e.g., at least 8,500 g/mol, at least 9,000 g/mol, at least 9,500 g/mol, at least 9,600 g/mol, at least 9,700 g/mol, at least 9,800 g/mol, at least 9,900 g/mol at least 10,000 g/mol, at least 10,500 g/mol) to less than 11,000 g/mol (e.g., less than 11,500 g/mol or 12,000 g/mol).

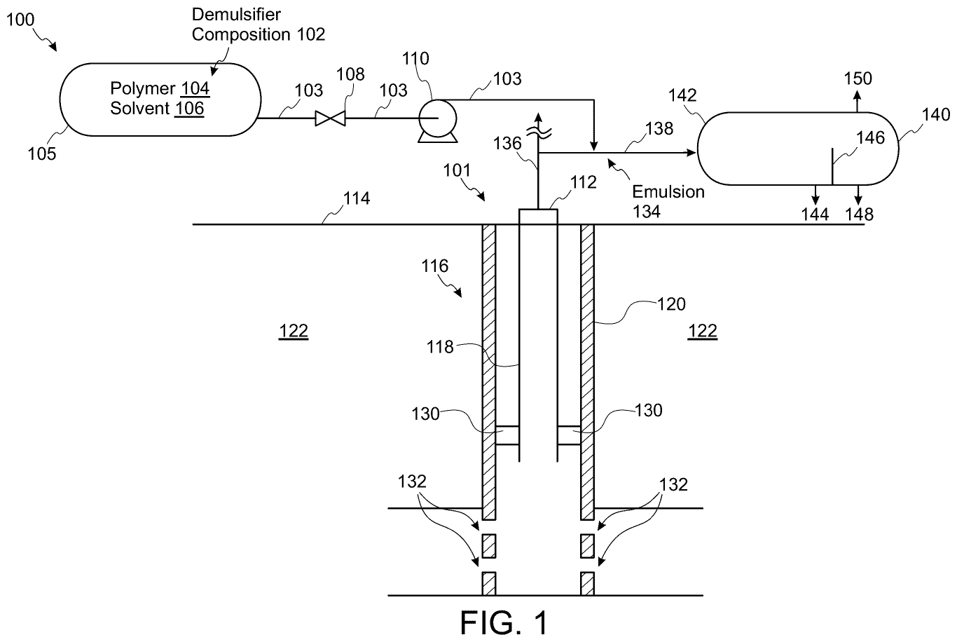

Referring to FIG. 1, a system 100 is shown that can deliver a demulsifier composition 102 to an emulsion 134 at a wellsite 101 in a method according to an embodiment of the present disclosure. In some embodiments, the system 100 includes a vessel 105 that comprises the demulsifier composition 102 which includes a polymer 104 and a solvent 106. The system 100 may include a wellbore 116 that is formed through a surface 114 of the Earth into the subterranean formation 122. The subterranean formation 122 may include an oil reservoir comprising crude oil.

In some embodiments, the crude oil comprises an emulsion 134 having an aqueous phase and an oil phase.

In some embodiments, the wellbore 116 includes a wellbore wall 120 that has been drilled to penetrate a portion of the subterranean formation 122, which may be formed out of one or more casing strings disposed therein. The casting strings of the wellbore wall 120 may be a series of connected pipes that are lowered into the wellbore 116 and cemented in place to form the wellbore 116 within the subterranean formation 122. Production tubing 118 may be disposed in the wellbore 116. In some embodiments, a wellbore head 112 is constructed at an entrance to the wellbore 116. The production tubing 118 may be coupled to the wellbore head 112 and configured to extend from the wellbore head 112 to a depth within the wellbore 116. The production tubing 112 may be held in place within the wellbore 116 by one or more packers 130. For example, the packer(s) 130 may be positioned between the wellbore wall 120 and the production tubing 118 to hold the production tubing 118 in place within the wellbore 116. The wellbore wall 120 may include one or more perforations 132 that provide fluid communication between crude oil reserves within the subterranean formation 122 and the wellbore 116.

In some embodiments, a production header line 136 is in fluid communication with the production tubing 118 via the production header 112. In some embodiments, the production header line 136 is positioned outside of the subterranean formation 122. In some embodiments, a flowline 138 is in fluid communication with the production header line 136. In some embodiments, the flowline 138 is positioned between the production tubing 118 and an emulsion separator vessel 140. Any suitable emulsion separator vessel 140 may be used, for example, an emulsion separator vessel 140 that includes an inlet 142 configured to receive the emulsion 134, an aqueous phase outlet 144 positioned upstream of an overflow weir 146, an oil phase outlet 148 positioned downstream of the overflow weir 146, and a gas outlet 150 configured on a top portion of the emulsion separator vessel 140.

The system 100 may include a pump 110 that is configured to transfer the demulsifier composition 102 from the vessel 105 to the flowline 138. A conduit 103 may place the vessel 105, the pump 110, and the flowline 138 in fluid communication. The system 100 may include a wellbore valve 108 configured to regulate the flow of fluids between the pump 110 and the flowline 138. The wellbore valve 108 may be moveable between an open position that is configured to allow fluid to flow through the wellbore valve 108 to the wellbore 116 and a closed position that is configured to mitigate, or otherwise prevent, the flow of fluid to pass through the wellbore valve 108 to the flowline 138. In some embodiments, the method may include providing the demulsifier composition 102 to a portion of the flowline 138 comprising the emulsion 134. For example, the pump 110 may be configured to transport the demulsifier composition 102 into the flowline 138 to contact the emulsion 134.

The demulsifier composition 102 is configured to separate the emulsion 134. For example, the demulsifier composition 102 is configured to at least partially separate the aqueous phase from the oil phase within the emulsion 134. For example, the mixture comprising the demulsifier composition 102 and the emulsion 134 may enter the emulsion separator vessel 140 through the inlet 142. As the mixture travels through the emulsion separator vessel 140, the demulsifier composition 102 separates the emulsion 134 into the aqueous phase and the oil phase. The aqueous phase may exit the emulsion separator vessel 140 through the aqueous phase outlet 144. The oil phase having the lighter density may flow over the overflow weir to the oil phase outlet 148. Any gas separated from the emulsion 134 may exit the emulsion separator vessel 140 through the gas outlet 150.

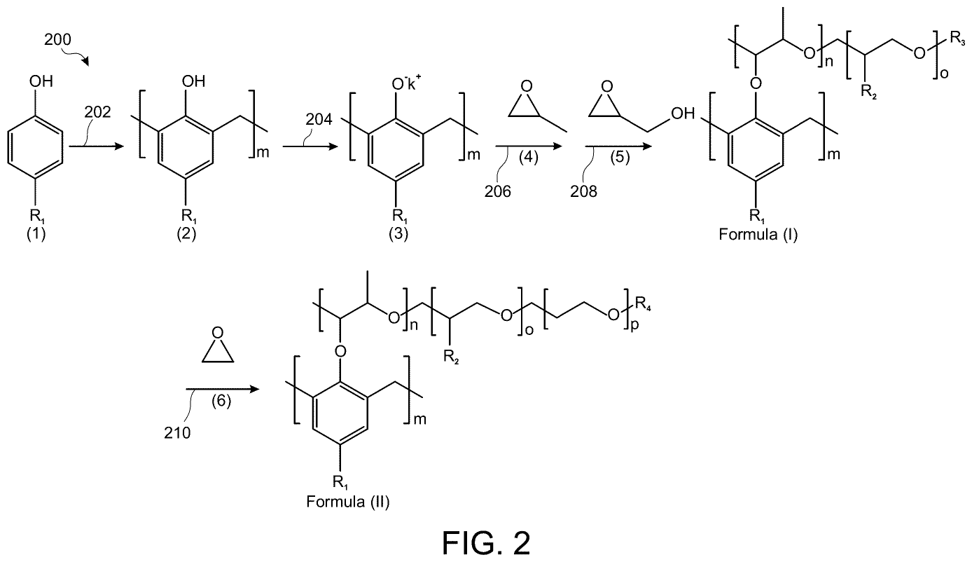

Referring to FIG. 2, an example method 200 for producing a polymer 104 is shown according to some embodiments of the present disclosure. At operation 202, the method 200 includes adding an acid to an alkylphenol (1) in a solvent. In some embodiments, the acid comprises, but is not limited to, concentrated H₂SO₄, acetic acid, HCl, or combinations thereof. In some embodiments, the solvent comprises, but is not limited to, cyclohexane, methanol, isopropanol, dichloromethane, or combinations thereof. In some embodiments, operation 202 includes stirring the solution under nitrogen for a duration. For example, operation 202 may include stirring the solution under nitrogen at a temperature that is less than the boiling point of the solvent for a duration. In one particular example, operation 202 includes stirring the solution under nitrogen at a temperature that is less than the boiling point of the solvent (e.g., at 85 °C. or less for 30 minutes to one day). In some embodiments, operation 202 includes adding paraformaldehyde over a duration. For example, operation 202 may include adding paraformaldehyde at 80 °C. to 100 °C. for one to two hours. Operation 202 may include refluxing solution to remove moisture, filtering to remove particulate, and drying to yield compound (2). In some embodiments, operation 202 includes refluxing using a Dean-Stark apparatus for four to six hours, filtering to remove particular, and drying under vacuum at 10 °C. to 50 °C.

At operation 204, the method 200 includes adding a first solution comprising an alkoxide and a solvent to a second solution comprising compound (2) and a solvent. In some embodiments, the alkoxide comprises, but is not limited it, KOMe, potassium ethoxide, or combinations thereof. In some embodiments, the solvent in the first solution comprises, but is not limited to, methanol, ethanol, or combinations thereof. In some embodiments, the solvent in the second solution comprises, but is not limited to, anhydrous dioxane, anhydrous DMF, anhydrous THF, or combinations thereof. Operation 204 may include stirring the mixture for a duration. For example, the mixture may be stirred at 65 °C. to 85 °C. for ten to 30 minutes. In some embodiments, operation 204 includes using a stream of nitrogen to remove the solvent and the residual salt may be dried under vacuum to obtain a mixture of compounds (2) and (3). For example, the residual salt may be dried under vacuum at 70 °C. to 85 °C. for two to four hours. In some embodiments, at operation 204, the mixture of compounds 2 and 3 are added to Na-dried and distilled dioxane. In some embodiments, the mixture of compounds 2 and 3 are added at a ratio of 20:14 in the Na-dried and distilled dioxane. In some embodiments, operation 204 is heated to 70 °C. Operation 204 may include removing the dioxane using a stream of nitrogen, which may remove most or all of the methanol (used in the preparation of potassium salt) and moisture.

At operation 206, the method 200 includes adding propylene oxide (4) to the mixture generated in operation 204. In some embodiments, adding the propylene oxide (4) to the mixture includes injecting the propylene oxide (4) using a syringe through a septum. Operation 206 may include stirring the mixture in a closed vessel at 80 °C. for six to 12 hours and another 24 hours at 90 °C. At operation 208, the method 200 includes adding glycidol (5) to the mixture generated in operation 206. For example, operation 208 may include adding glycidol dropwise over ten to 20 minutes under nitrogen at 80 °C. The reaction mixture may subsequently be stirred at 80 °C. to 95 °C. for 12 to 24 hours to yield a compound having formula (I) described above. In some embodiments, formula (I) may be used as the polymer 104 in the demulsifier composition 102.

For example, operation 208 may further include adding the polymer 104 to the solvent 106, as described above, to obtain the demulsifier composition 102.

At operation 210, the method 200 may further include adding ethylene oxide (6) into the reaction mixture to obtain a compound having a structure according to formula (II). Operation 210 may also include removing the solvent and drying under vacuum at 70 °C. to purify the compound having the structure according to formula (II). In some embodiments, formula (II) may be used as the polymer 104 in the demulsifier composition 102. In some embodiments, operation 210 further includes adding the polymer 104 to the solvent 106, as described above, to obtain the demulsifier composition 102.

### EXAMPLES

### Example 1

In this Example, concentrated H₂SO₄ (260 mg) was added to a solution of p-nonylphenol (1) (20.5 g, 93 mmol) in cyclohexane (110 mL). The solution was stirred using a magnetic stir bar under N₂ at 80 °C. for 30 min. Powder paraformaldehyde (2.79 g, 93 mmol) was added portion-wise at 80 °C. over a period of 1 h (exothermic reaction occurred). The solution was then refluxed for 4 h using a Dean-Stark apparatus to remove moisture. The reaction mixture was then filtered to remove minor black particles. The filtrate upon removal of the solvent followed by drying under vacuum at 50 °C. afforded brown-colored solid Novolac compound (2) (21.5 g), as shown in FIG. 2.

A solution of 20 wt. % KOMe in methanol (5.61 g, 20 mmol) was added to a cloudy mixture of Novolac 2 (≈8.0 g, 34 mmol) in anhydrous dioxane (Na distilled) (18 g). The mixture became a clear solution which was stirred at 65 °C. for 10 min. Using a gentle stream of N₂, the solvent dioxane was removed and the residual salt was dried under vacuum at 70 °C. for 2 h to obtain a mixture of compounds 2 and 3 (8.7 g) in a ratio of 20:14 as a light brown solid.

A mixture of compounds 2 and 3 (2.05 g, ≈8.0 mmol) in a ratio of 20:14 in Na-dried and distilled dioxane (15 mL) was heated to 70 °C. Using a gentle stream of N₂, dioxane (≈4 g) was removed to ensure the complete removal of any methanol (used in the preparation of potassium salt) and moisture. Propylene oxide (4) (4.65 g, 80 mmol) was injected using a syringe through the septum. The reaction mixture in the closed vessel was stirred at 80 °C. for 6 h and another 24 h at 90 °C. The ¹H NMR revealed the almost complete consumption of propylene oxide. Thereafter, freshly distilled glycidol (5) (2.37 g, 2.12 mL, 32 mmol) was added dropwise (10 min) under N₂ at 80 °C. and the reaction mixture was then stirred at 95 °C. for 24 h to obtain a compound having a structure according to formula (I). Then ethylene oxide (6) (4.65 g, 80 mmol) was injected into the mixture. After removal of the solvent and drying under vacuum at 70 °C., a compound having a structure according to formula (II) (8.9 g) was obtained as a light-brownish semisolid.

A field emulsion sample was collected from production header containing 60% water cut. 50.0 mL of emulsion was transferred to a 100 mL graduated settling bottle/tube. The demulsifier sample was prepared in organic solvent system (Xylene 10 ml+Methanol 0.5 mL) before dosing into the emulsion. A known amount of demulsifiers, 30 ppm was added to the emulsion (50 mL) and mixed by handshaking for a period of time (1-5 min). Then these bottles/tubes with emulsion and demulsifier were placed vertically in a water bath at 50 °C. The volume (mL) of water separated was measured with time.

TABLE 1
Formulation of active intermediates

| | | |
|---|---|---|
| 15-A | Blank/Field emulsion | — |
| 15-B | Formulation contains linear phenolic resin, Phenolic resin-PPO-HPG-EO | 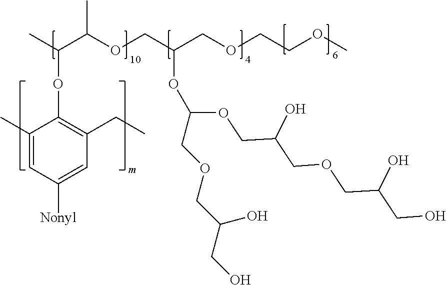 |
| 15-C | Formulation contains linear phenolic resin, Phenolic resin-PPO-HPG | 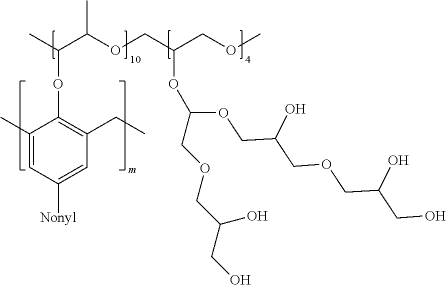 |

TABLE 2
Volumes of separated water with different formulation at 130 °F
for different time points, against field emulsion having 60% water cut.

| | | | | | | Efficiency |
|---|---|---|---|---|---|---|
| | | | | | | (%) |
| Polymer used in the | | 5 | 10 | 15 | 20 | after 20 |
| Formulation | Sample | (min) | (min) | (min) | (min) | min |
| Blank | 15-A | 0 | 0 | 0 | 0 | 0.0 |
| Phenolic resin-PPO- | 15-B | 6 | 15 | 19 | 20 | 66.67 |
| HPG | | | | | | |
| Phenolic resin- PPO- | 15-C | 15 | 20 | 25 | 30 | 100 |
| HPG-EO | | | | | | |

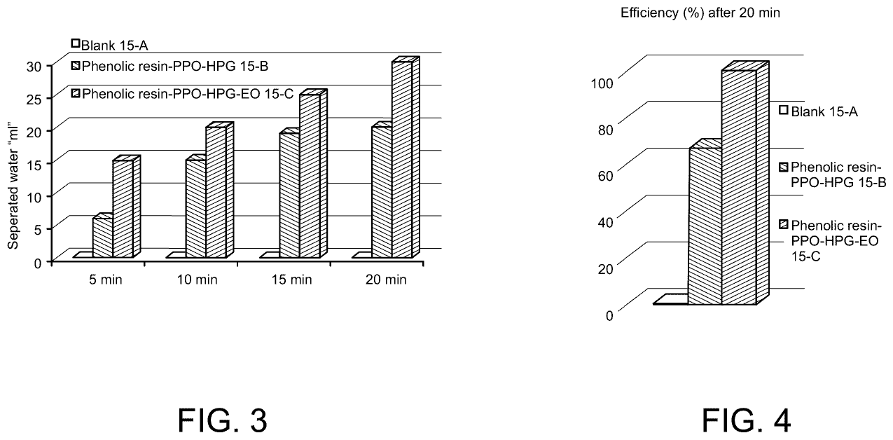

FIG. 3 shows a graph of separated water volume versus time of the demulsifier compositions at 30 ppm and 130 TF. At 5 minutes, the blank 15-A formulation separated 0 mL of water, the phenolic resin-PPO-HPG 15B formulation separated 6 mL of water, and the phenolic resin-PPO-HPC-EO separated 15 mL of water. At 10 minutes, the blank 15-A formulation separated 0 mL of water, the phenolic resin-PPO-HPG 15B formulation separated 15 mL of water, and the phenolic resin-PPO-HPC-EO separated 20 mL of water. At 15 minutes, the blank 15-A formulation separated 0 mL of water, the phenolic resin-PPO-HPG 15B formulation separated 19 mL of water, and the phenolic resin-PPO-HPC-EO separated 25 mL of water. At 20 minutes, the blank 15-A formulation separated 0 mL of water, the phenolic resin-PPO-HPG 15B formulation separated 20 mL of water, and the phenolic resin-PPO-HPC-EO separated 30 mL of water.

FIG. 4 shows a graph of water separation efficiency versus time for the demulsifier compositions at 30 ppm and 130 °F. After 20 minutes, the blank 15-A formulation had a 0% separation efficiency, the phenolic resin-PPO-HPG 15B formulation had a 67% separation efficiency, and the phenolic resin-PPO-HPC-EO separated had a 100% separation efficiency.

In an example implementation, a composition is provided. The composition includes a solvent and a polymer having a structure according to the following formula (I):

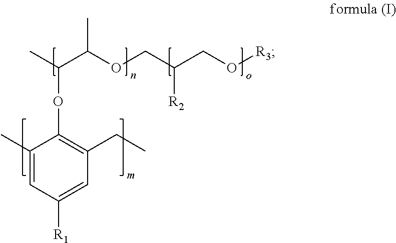

where R₁ is a C₁-C₂₀ alkyl, where R₂ comprises a linear or branched polyglycerol, where R₃ is selected from a C₁-C₃ alkyl or a group represented by the following formula (II):

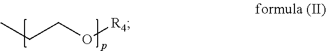

where R₄ is a C₁-C₃ alkyl; and where m, n, o, and p are integers independently ranging from ≥1 and ≤100.

In an example implementation combinable with any other example implementation, the linear or branched polyglycerol has from 6 to 120 carbon atoms. In an example implementation combinable with any other example implementation, the linear or branched polyglycerol has from 6 to 60 carbon atoms.

In an example implementation combinable with any other example implementation, R₂ is a group represented by the following formula (III):

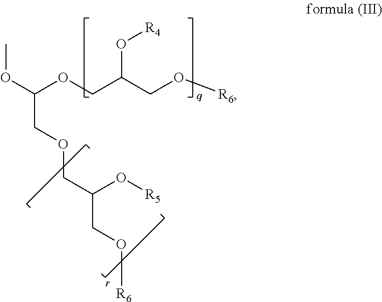

where q and r are integers independently ranging from ≥1 and ≤15, where R₄ and R₅ are independently selected from hydrogen or a group represented by the following formula (IV):

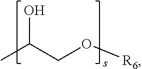

where s is an integer ranging from ≥1 and ≤15, and where R₆ is selected from hydrogen or a group represented by the following formula (V):

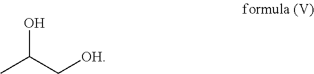

In an example implementation combinable with any other example implementation, q, r, or s are an integer ranging from ≥4 and ≤10. In an example implementation combinable with any other example implementation, m is an integer ranging from ≥1 and ≤10. In an example implementation combinable with any other example implementation, n is an integer ranging from ≥50 and ≤80. In an example implementation combinable with any other example implementation, o is an integer ranging from ≥10 and ≤40. In an example implementation combinable with any other example implementation, p is an integer ranging from ≥40 and ≤60.

In an example implementation combinable with any other example implementation, the solvent is present in an amount from 30 wt. % to 75 wt. %, based on a total weight of the demulsifier composition. In an example implementation combinable with any other example implementation, the polymer is present in an amount from 25 wt. % to 50 wt. %, based on the total weight of the demulsifier composition.

In an example implementation combinable with any other example implementation, the solvent comprises an aromatic solvent and a polar organic solvent. In an example implementation combinable with any other example implementation, the aromatic solvent is selected from one or more member consisting of benzene, toluene, ethyl benzene, and xylene. In an example implementation combinable with any other example implementation, the polar organic solvent comprises methanol.

In an example implementation combinable with any other example implementation, the polymer has a number average molecular weight (Mₙ) from 3,800 to 4,500 g/mol. In an example implementation combinable with any other example implementation, the polymer has a weight average molecular weight (M_{w}) from 8,000 to 12,000 g/mol.

In another example implementation, a method is provided. The method may include providing a demulsifier composition to a flowline in fluid communication with a portion of a subterranean formation, where the flowline comprises an emulsion that contains an aqueous phase and an oil phase. The demulsifier composition includes a solvent and a polymer having a structure according to the following formula (I):

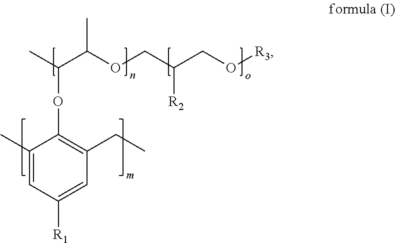

where R₁ is a C₁-C₂₀ alkyl, where R₂ comprises a linear or branched polyglycerol, where R₃ is selected from a C₁-C₃ alkyl or a group represented by the following formula (II):

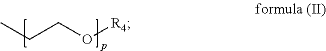

where R₄ is a C₁-C₃ alkyl, and where m, n, o, and p are integers ranging from ≥1 and ≤100.

In an example implementation combinable with any other example implementation, the linear or branched polyglycerol has from 6 to 120 carbon atoms. In an example implementation combinable with any other example implementation, where R₂ is a group represented by the following formula (III):

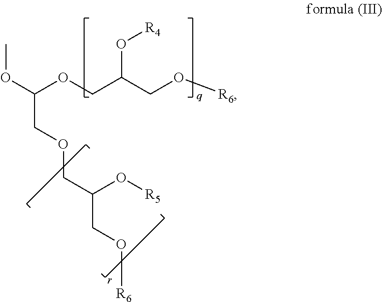

where q and r are integers ranging from ≥1 and ≤15, where R₄ and R₅ are independently selected from hydrogen or a group represented by the following formula (IV):

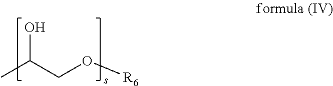

where s is an integer ranging from ≥1 and ≤15, and where R₆ is selected from hydrogen or a group represented by the following formula (V):

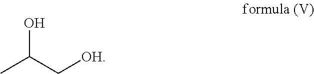

In an example implementation combinable with any other example implementation, wherein m is an integer ranging from 1 and ≤10, n is an integer ranging from 50 and ≤80, o is an integer ranging from 10 and ≤40, and p is an integer ranging from 40 and ≤60.

In an example implementation combinable with any other example implementation, the solvent is present in an amount from 30 wt. % to 75 wt. %, based on a total weight of the demulsifier composition. In an example implementation combinable with any other example implementation, the polymer is present in an amount from 25 wt. % to 50 wt. %, based on the total weight of the demulsifier composition.

In an example implementation combinable with any other example implementation, the polymer has a number average molecular weight (Mₙ) from 3,800 to 4,500 g/mol. In an example implementation combinable with any other example implementation, the polymer has a weight average molecular weight (M_{w}) from 8,000 to 12,000 g/mol.

In an example implementation combinable with any other example implementation, the demulsifier composition demulsifies the emulsion present in the flowline to separate the aqueous phase from the oil phase.

What is claimed is:

1. A composition comprising:
a solvent; and
a polymer having a structure according to the following formula (I): 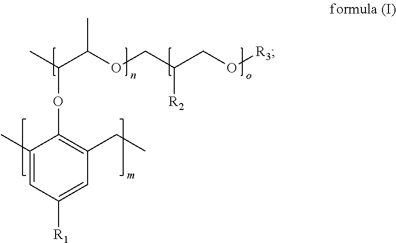
wherein R₁ is a C₁-C₂₀ alkyl;
wherein R₂ comprises a linear or branched polyglycerol;
wherein R₃ is selected from a C₁-C₃ alkyl or a group represented by the following formula (II): 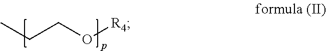
wherein R₄ is a C₁-C₃ alkyl; and
wherein m, n, o, and p are integers independently ranging from ≥1 and ≤100.

2. The composition of claim 1, wherein the linear or branched polyglycerol has from 6 to 120 carbon atoms.

3. The composition of claim 1, wherein the linear or branched polyglycerol has from 6 to 60 carbon atoms.

4. The composition of claim 1, wherein R₂ is a group represented by the following formula (III): 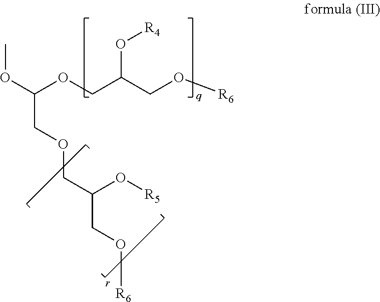
wherein q and r are integers independently ranging from ≥1 and ≤15;
wherein R₄ and R₅ are independently selected from hydrogen or a group represented by the following formula (IV): 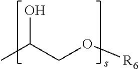
wherein s is an integer ranging from ≥1 and ≤15; and
wherein R₆ is selected from hydrogen or a group represented by the following formula (V):

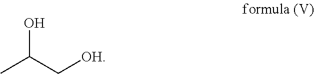

5. The composition of claim 4, wherein q, r, or s are an integer ranging from ≥4 and ≤10.

6. The composition of claim 1, wherein m is an integer ranging from ≥1 and ≤10.

7. The composition of claim 1, wherein n is an integer ranging from ≥50 and ≤80.

8. The composition of claim 1, wherein o is an integer ranging from ≥10 and ≤40.

9. The composition of claim 1, wherein p is an integer ranging from ≥40 and ≤60.

10. The composition of claim 1, wherein the solvent is present in an amount from 30 wt. % to 75 wt. %, based on a total weight of the demulsifier composition; and
wherein the polymer is present in an amount from 25 wt. % to 50 wt. %, based on the total weight of the demulsifier composition.

11. The composition of claim 1, wherein the solvent comprises an aromatic solvent and a polar organic solvent.

12. The composition of claim 11, wherein the aromatic solvent is selected from one or more member consisting of benzene, toluene, ethyl benzene, and xylene; and
wherein the polar organic solvent comprises methanol.

13. The composition of claim 1, wherein the polymer has a number average molecular weight (Mₙ) from 3,800 to 4,500 g/mol.

14. The composition of claim 1, wherein the polymer has a weight average molecular weight (M_{w}) from 8,000 to 12,000 g/mol.

15. A method comprising:
providing a demulsifier composition to a flowline in fluid communication with a portion of a subterranean formation, wherein the flowline comprises an emulsion that contains an aqueous phase and an oil phase, wherein the demulsifier composition comprises:
a solvent; and
a polymer having a structure according to the following formula (I): 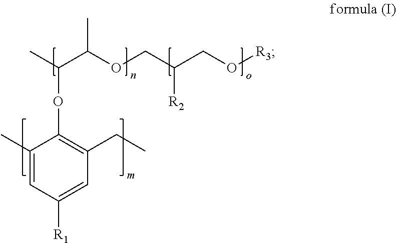
wherein R₁ is a C₁-C₂₀ alkyl;
wherein R₂ comprises a linear or branched polyglycerol;
wherein R₃ is selected from a C₁-C₃ alkyl or a group represented by the following (II): 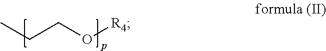
wherein R₄ is a C₁-C₃ alkyl; and
wherein m, n, o, and p are integers ranging from ≥1 and ≤100.

16. The method of claim 15, wherein the linear or branched polyglycerol has from 6 to 120 carbon atoms.

17. The method of claim 15, wherein R₂ is a group represented by the following formula (III): 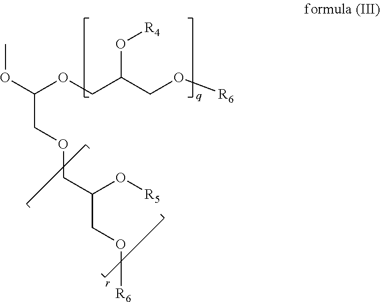
wherein q and r are integers ranging from ≥1 and ≤15;
wherein R₄ and R₅ are independently selected from hydrogen or a group represented by the following formula (IV): 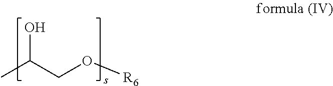
wherein s is an integer ranging from ≥1 and ≤15; and
wherein R₆ is selected from hydrogen or a group represented by the following formula (V):

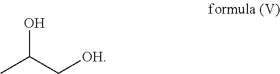

18. The method of claim 15, wherein:
m is an integer ranging from ≥1 and ≤10;
n is an integer ranging from ≥50 and ≤80;
o is an integer ranging from ≥10 and ≤40; and
p is an integer ranging from ≥40 and ≤60.

19. The method of claim 15, wherein the solvent is present in an amount from 30 wt. % to 75 wt. %, based on a total weight of the demulsifier composition; and
wherein the polymer is present in an amount from 25 wt. % to 50 wt. %, based on the total weight of the demulsifier composition.

20. The method of claim 15, wherein the polymer has a number average molecular weight (Mₙ) from 3,800 to 4,500 g/mol; and
wherein the polymer has a weight average molecular weight (M_{w}) from 8,000 to 12,000 g/mol.
